(19) United States
(12) Patent Application Publication
(10) Pub. No.: US 2014/0244697 A1
(43) Pub. Date: Aug. 28, 2014

(54) METHOD AND DEVICE FOR DISPLAYING FILES

(71) Applicant: Xiaomi Inc., Beijing (CN)

(72) Inventors: Shen LI, Beijing (CN); Tao Guo, Beijing (CN); Ning Liu, Beijing (CN)

(73) Assignee: Xiaomi Inc., Beijing (CN)

(21) Appl. No.: 14/183,119

(22) Filed: Feb. 18, 2014

Related U.S. Application Data
(63) Continuation of application No. PCT/CN2013/083452, filed on Sep. 13, 2013.

(30) Foreign Application Priority Data
Feb. 22, 2013 (CN) 201310057165.8

(51) Int. Cl. G06F 17/30

(52) U.S. Cl. CPC G06F 17/30126
USPC 707/821

(57) ABSTRACT

A method for a device to display files includes acquiring, when opening an application, characteristic information of a plurality of content files relating to the application; determining a display attribute of each of the content files based on the acquired characteristic information, the determined display attribute being one of a first attribute, a second attribute, and a third attribute; and hiding ones of the content files with the determined display attribute being the first attribute or the second attribute, and displaying ones of the content files with the determined display attribute being the third attribute.

### CROSS REFERENCE TO RELATED APPLICATIONS

This application is a continuation of International Application No. PCT/CN2013/083452, filed Sep. 13, 2013, which is based upon and claims priority to Chinese Patent Application No. 201310057165.8, filed Feb. 22, 2013, the entire contents of all of which are incorporated herein by reference.

### TECHNICAL FIELD

The present disclosure generally relates to the technical field of communication and, more particularly, to a method and device for displaying files.

### BACKGROUND

With the development of communication technologies, a number of applications installed on a device, such as a mobile phone, increases, and a number of content files, such as pictures, relating to each of the applications increases as well. As a result, for example, a great number of pictures that are carried or buffered by an application will be displayed on the device when a user uses the application, which brings inconvenience because the user may not want to view all of the pictures, and also reduces efficiency for the device to search for a picture the user wants to view.

### SUMMARY

According to a first aspect of the present disclosure, there is provided a method for a device to display files, comprising: acquiring, when opening an application, characteristic information of a plurality of content files relating to the application; determining a display attribute of each of the content files based on the acquired characteristic information, the determined display attribute being one of a first attribute, a second attribute, and a third attribute; and hiding ones of the content files with the determined display attribute being the first attribute or the second attribute, and displaying ones of the content files with the determined display attribute being the third attribute.

According to a second aspect of the present disclosure, there is provided a device for displaying files, comprising: a processor; and a memory for storing instructions executable by the processor; wherein the processor is configured to: acquire, when opening an application, characteristic information of a plurality of content files relating to the application; determine a display attribute of each of the content files based on the acquired characteristic information, the determined display attribute being one of a first attribute, a second attribute, and a third attribute; and hide ones of the content files with the determined display attribute being the first attribute or the second attribute, and display ones of the content files with the determined display attribute being the third attribute.

According to a third aspect of the present disclosure, there is provided a non-transitory computer-readable medium having stored therein instructions that, when executed by a processor of a device, causes the device to perform a method for displaying files, the method comprising: acquiring, when opening an application, characteristic information of a plurality of content files relating to the application; determining a display attribute of each of the content files based on the acquired characteristic information, the determined display attribute being one of a first attribute, a second attribute, and a third attribute; and hiding ones of the content files with the determined display attribute being the first attribute or the second attribute, and displaying ones of the content files with the determined display attribute being the third attribute.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for a device to display files, according to an exemplary embodiment.

FIG. 2 is a flowchart of a method for a device to display files, according to an exemplary embodiment.

FIG. 3 is a block diagram of a device for displaying files, according to an exemplary embodiment.

FIG. 4 is a block diagram of a device for displaying files, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

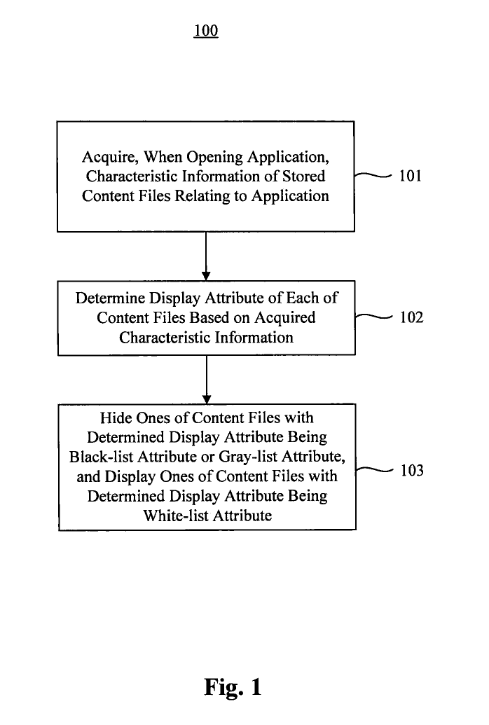

FIG. 1 is a flowchart of a method 100 for a device to display files, according to an exemplary embodiment. For example, the device may be a mobile phone, a tablet computer, etc. Referring to FIG. 1, the method 100 includes the following steps.

In step 101, the device acquires, when opening an application, characteristic information of stored content files relating to the application. For example, the application may be an application for viewing pictures, such as a photo gallery application. Accordingly, the content files are picture files. Also for example, the application may be a music player. Accordingly, the content files are music files.

In step 102, the device determines a display attribute of each of the content files based on the acquired characteristic information. For example, the determined display attribute may be a first attribute, referred to herein as a black-list attribute, or a second attribute, referred to herein as a gray-list attribute, or a third attribute, referred to herein as a white-list attribute, as described below.

In step 103, the device hides ones of the content files with the determined display attribute being the black-list attribute or the gray-list attribute, and displays ones of the content files with the determined display attribute being the white-list attribute.

In the illustrated embodiment, when the application is opened on the device, the device loads a startup file corresponding to the application, and acquires the content files relating to the application. For example, when a photo gallery application is opened on the device, the device acquires a plurality of content files having different storage paths, such as photos captured by cameras, pictures downloaded from microblogs, pictures downloaded from on-line chatting software, etc. Some of the content files are unnecessary for view by a user and, thus, displaying those content files not only occupies processor resources, but also lengthens time for the device to search for, e.g., a picture the user wants to view. Therefore, the device displays ones of the content files based on the determined display attribute of each of the content files.

In exemplary embodiments, the black-list attribute indicates that a content file should be hidden. For example, if the device uses an Android operating system, the device determines files that have a file name containing “.nomedia” or have a directory name headed by “.” to have the black-list attribute. For example, these files are filtered out of a media library and are not scanned by the device.

In exemplary embodiments, the gray-list attribute indicates that a directory of a content file is set as a hidden directory by default and, thus, the content file is hidden and not displayed by default. But the content file can be displayed by changing a setting of the application.

In exemplary embodiments, the whitelist attribute indicates that a content file is a favorite file of the user, such as in a directory set by the user as a favorite directory. Accordingly, the file with the white-list attribute is displayed on top or displayed with highlighting by default.

In exemplary embodiments, the black-list attribute is set by system, which cannot be reset by the user, and the gray-list attribute and the white-list attribute can be set by the user. For example, a first picture album can be set as a hidden picture album, and a second picture album can be set as a favorite picture album. In one exemplary embodiment, the device uploads paths of favorite picture albums and hidden picture albums set by the user to a server. The server compiles aggregated statistics to obtain a number of times of each content file being set as favorite and a number of times of each content file being set as hidden. The server further includes the paths of, e.g., the top ten content files being set as favorite into a white list, and includes the file paths, e.g., the top ten content files being set as hidden into a gray list.

In one exemplary embodiment, the device acquires a current version of the gray list and a current version of the white list from the server at predetermined times. The device further sets the paths on the white list to be favorite by default, and sets the paths on the gray list to be hidden by default.

In one exemplary embodiment, the device uses a format of a content file as the characteristic information of the content file. Accordingly, the device compares the format of the content file with a plurality of predetermined formats. The device further determines the display attribute of the content file to be the black-list attribute if the format of the content file matches a first one of the plurality of predetermined formats, determines the display attribute of the content file to be the gray-list attribute if the format of the content file matches a second one of the plurality of predetermined formats, and determines the display attribute of the content file to be the white-list attribute if the format of the content file matches a third one of the plurality of predetermined formats. For example, if the device determines that the format of the content file matches a “.nomedia” file format or determines that the content file has a directory name headed by “.”, the device determines the display attribute of the content file to be the black-list attribute.

In one exemplary embodiment, the device uses a number of times a content file is hidden by the user as the characteristic information of the content file. Accordingly, the device acquires the number of times the content file is hidden. The device further determines the display attribute of the content file to be the black-list attribute if the acquired number of times is larger than a first preset threshold value, determines the display attribute of the content file to be the gray-list attribute if the acquired number of times is smaller than the first preset threshold value and larger than a second preset threshold value, and determines the display attribute of the content file to be the white-list attribute if the acquired number of times is smaller than the second preset threshold value.

In one exemplary embodiment, the device uses a display attribute mark of a content file set by the user as the characteristic information of the content file. Accordingly, the device determines the display attribute of the content file to be the black-list attribute if it is detected that the display attribute mark of the content file is set as the black-list attribute, determines the display attribute of the content file to be the gray-list attribute if it is detected that the display attribute mark of the content file is set as the gray-list attribute; and determines the display attribute of the content file to be the white-list attribute if it is detected that the display attribute mark of the content file is set as the white-list attribute. For example, the display attribute mark of the content file is set or modified by the user through the application.

In one exemplary embodiment, a display attribute of a content file is locally determined at the device, and the device uploads the determined display attribute of the content file to a server. In one exemplary embodiment, a display attribute of a content file is determined at the server, and the device downloads the determined display attribute of the content file from the server.

In one exemplary embodiment, the application is an application for viewing pictures, such as a photo gallery application. Accordingly, the device hides pictures with the determined display attribute being the black-list attribute or the gray-list attribute, and displays pictures with the determined display attribute being the white-list attribute. In one exemplary embodiment, the application is a music player. Accordingly, the device hides music files with the determined display attribute being the black-list attribute or the gray-list attribute, and displays music files with the determined display attribute being the white-list attribute.

As a result, the method 100 increases a startup speed of the application and efficiency of the application to search for a content file requested by the user, thus improving user experience.

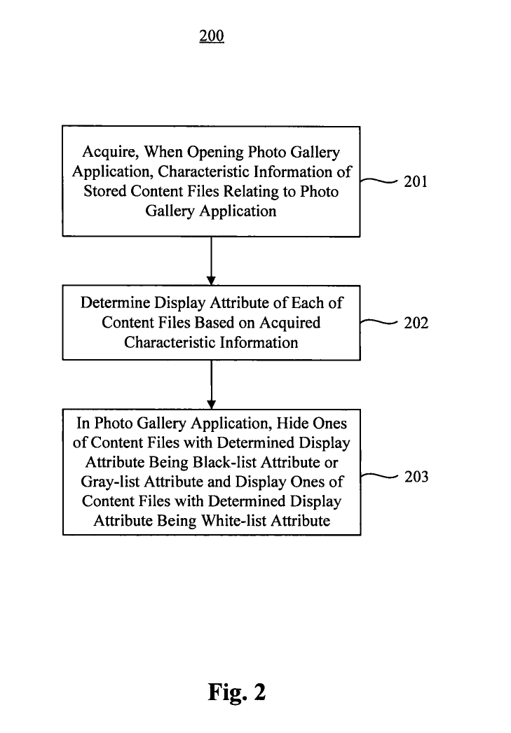

FIG. 2 is a flowchart of a method 200 for a device to display files, according to an exemplary embodiment. For example, the device may be a mobile phone, a tablet computer, etc. In the illustrated embodiment, an application for viewing pictures, such as a photo gallery application, is to be opened on the device. Referring to FIG. 2, the method 200 includes the following steps.

In step 201, the device acquires, when opening the photo gallery application, characteristic information of each of stored content files relating to the photo gallery application, such as picture albums, picture files uploaded to cloud servers, pictures buffered by using client software, etc. The characteristic information may be a format of the content file, a number of times the content file has been hidden by the user, a display attribute mark of the content file, etc.

In step 202, the device determines a display attribute of each of the content files based on the determined characteristic information. For example, the device determines a corresponding relationship between the characteristic information and the display attributes in advance, and determines the display attribute of the content file based on the corresponding relationship between the characteristic information and the display attribute.

In one exemplary embodiment, the device uses a format of a content file as the characteristic information of the content file. Accordingly, the device compares the acquired format of the content file with a plurality of predetermined formats. The device further determines the display attribute of the content file to be the black-list attribute if the format of the content file matches a first one of the plurality of predetermined formats, determines the display attribute of the content file to be the gray-list attribute if the format of the content file matches a second one of the plurality of predetermined formats, and determines the display attribute of the content file to be the white-list attribute if the format of the content file matches a third one of the plurality of predetermined formats.

In one exemplary embodiment, the device uses a number of times a content file has been hidden by the user as the characteristic information of the content file. It is also assumed that a first threshold value is preset to be 15, and a second threshold value is preset to be 10. Accordingly, the device acquires the number of times the content file has been hidden. The device further determines the display attribute of the content file to be the black-list attribute if the acquired number of times is larger than the first preset threshold value 15, determines the display attribute of the content file to be the gray-list attribute if the acquired number of times is smaller than the first preset threshold value 15 and larger than the second preset threshold value 10, and determines the display attribute of the content file to be the white-list if the acquired number of times is smaller than the second preset reference threshold value 10.

In one exemplary embodiment, the device uses a display attribute mark of a content file set by the user as the characteristic information of the content file. Accordingly, the device determines the display attribute of the content file to be the black-list attribute if it is detected that the content file is set as the black-list attribute, determines the display attribute of the content file to be the gray-list attribute if it is detected that the content file is set as the gray-list attribute, and determines the display attribute of the content file to be the white-list attribute if it is detected that the content file is set as the white-list attribute.

Still referring to FIG. 2, in step 203, in the photo gallery application, the device hides content files with the determined display attribute being the black-list attribute or the gray-list attribute, and displays content files with the determined display attribute being the white-list attribute.

In the situation of the application being an application for playing music, such as a music player, a part of stored music files may be hidden and not be played according to a method similar to the method 200.

As a result, the method 200 increases a startup speed of the application and efficiency for the device to search for, e.g., a picture the user wants to view or a song the user wants to listen to, thus improving user experience.

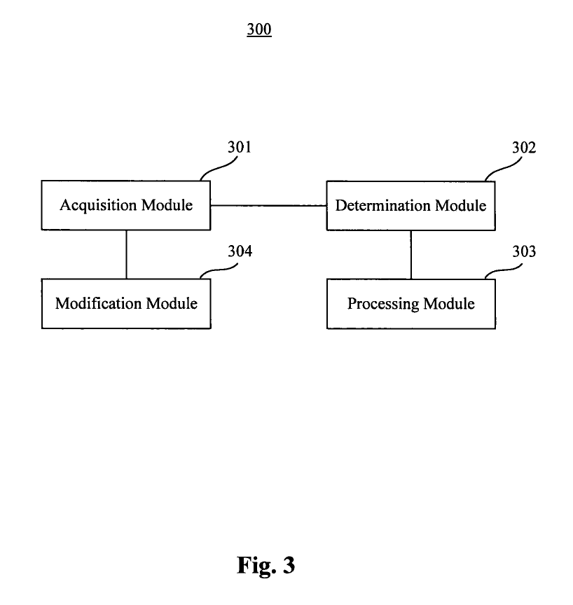

FIG. 3 is a block diagram of a device 300 for displaying files, according to an exemplary embodiment. For example, the device 300 may be a mobile phone, a tablet computer, etc. Referring to FIG. 3, the device 300 includes an acquisition module 301, a determination module 302, a processing module 303, and a modification module 304.

In exemplary embodiments, the acquisition module 301 is configured to acquire, when an application is opened on the device, characteristic information of stored content files relating to the application program. The determination module 302 is configured to determine a display attribute of each of the content files based on the acquired characteristic information. The processing module 303 is configured to hide ones of the content files with the determined display attribute being the black-list attribute or the gray-list attribute, and display ones of the content files with the determined display attribute being the white-list attribute. The modification module 304 is configured to modify a display attribute mark of a content file through the application.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

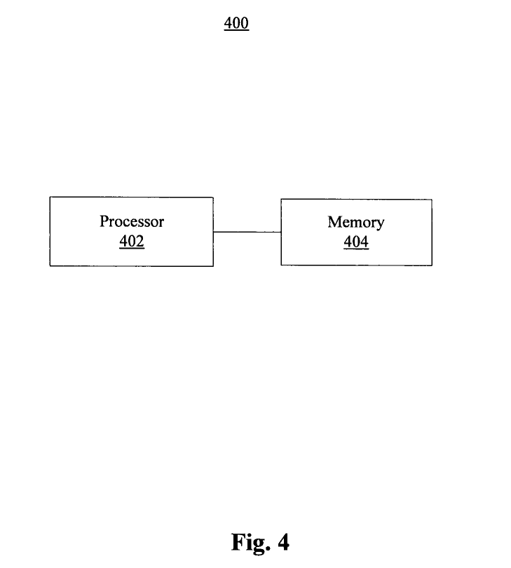

FIG. 4 is a block diagram of a device 400 for displaying files, according to an exemplary embodiment. For example, the device 400 may be a mobile phone, a tablet computer, etc. Referring to FIG. 4, the device 400 includes a processor 402 configured to execute program instructions to perform the above described methods for displaying files, and a memory 404 configured to store information and program instructions, and otherwise facilitate operation of the processor 402.

In exemplary embodiments, there is also provided a non-transitory computer-readable medium including instructions, such as included in the memory 404, executable by the processor 402 in the device 400, for performing the above described methods for displaying files. For example, the non-transitory computer-readable medium may be a compact disc read-only memory (CD-ROM), a flash disk, a mobile hard disk, etc.

Other embodiments of the invention will be apparent to those skilled in the art from consideration of the specification and practice of the invention disclosed herein. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a device to display files, comprising:
acquiring, when opening an application, characteristic information of a plurality of content files relating to the application;
determining a display attribute of each of the content files based on the acquired characteristic information, the determined display attribute being one of a first attribute, a second attribute, and a third attribute; and
hiding ones of the content files with the determined display attribute being the first attribute or the second attribute, and displaying ones of the content files with the determined display attribute being the third attribute.

2. The method according to claim 1, wherein the device uses a format of a first one of the content files as the characteristic information of the first content file, the determining further comprising:
comparing the format of the first content file with a plurality of predetermined formats;
determining the display attribute of the first content file to be the first attribute if the format of the first content file matches a first one of the plurality of predetermined formats;
determining the display attribute of the first content file to be the second attribute if the format of the first content file matches a second one of the plurality of predetermined formats; and
determining the display attribute of the first content file to be the third attribute if the format of the first content file matches a third one of the plurality of predetermined formats.

3. The method according to claim 2, wherein the determining of the display attribute of the first content file comprises:
determining the display attribute of the first content file to be the first attribute if it is determined that the format of the first content file matches a “.nomedia” file format or that the first content file has a directory name headed by “.”.

4. The method according to claim 1, wherein the device uses a number of times a first one of the content files has been hidden by a user as the characteristic information of the first content file, the determining further comprising:
acquiring the number of times the first content file has been hidden;
determining the display attribute of the first content file to be the first attribute if the acquired number of times is larger than a first preset threshold value;
determining the display attribute of the first content file to be the second attribute if the acquired number of times is smaller than the first preset threshold value and larger than a second preset threshold value; and
determining the display attribute of the first content file to be the third attribute if the acquired number of times is smaller than the second preset threshold value.

5. The method according to claim 1, wherein the device uses a display attribute mark of a first one of the content files set by a user as the characteristic information of the first content file, the determining further comprising:
determining the display attribute of the first content file to be the first attribute if it is detected that the display attribute mark of the first content file is set as the first attribute;
determining the display attribute of the first content file to be the second attribute if it is detected that the display attribute mark of the first content file is set as the second attribute; and
determining the display attribute of the first content file to be the third attribute if it is detected that the display attribute mark of the first content file is set as the third attribute.

6. The method according to claim 5, wherein the display attribute mark of the first content file is modified through the application.

7. The method according to claim 1, wherein
the device uploads the determined display attribute of a first one of the content files to a server.

8. The method according to claim 1, wherein when the application is an application for viewing pictures, the hiding and the displaying comprise:
hiding a first plurality of pictures with the determined display attribute being the first attribute or the second attribute; and
displaying a second plurality of pictures with the determined display attribute being the third attribute.

9. The method according to claim 1, wherein when the application is a music player, the hiding and the displaying comprise:
hiding a first plurality of music files with the determined display attribute being the first attribute or the second attribute; and
displaying a second plurality of music files with the determined display attribute being the third attribute.

10. A device for displaying files, comprising:
a processor; and
a memory for storing instructions executable by the processor;
wherein the processor is configured to:
acquire, when opening an application, characteristic information of a plurality of content files relating to the application;
determine a display attribute of each of the content files based on the acquired characteristic information, the determined display attribute being one of a first attribute, a second attribute, and a third attribute; and
hide ones of the content files with the determined display attribute being the first attribute or the second attribute, and display ones of the content files with the determined display attribute being the third attribute.

11. The device according to claim 10, wherein the device uses a format of a first one of the content files as the characteristic information of the first content file, the processor being further configured to:
compare the format of the first content file with a plurality of predetermined formats;
determine the display attribute of the first content file to be the first attribute if the format of the first content file matches a first one of the plurality of predetermined formats;
determine the display attribute of the first content file to be the second attribute if the format of the first content file matches a second one of the plurality of predetermined formats; and
determine the display attribute of the first content file to be the third attribute if the format of the first content file matches a third one of the plurality of predetermined formats.

12. The device according to claim 11, the processor being further configured to:
determine the display attribute of the first content file to be the first attribute if it is determined that the format of the first content file matches a “.nomedia” file format or that the first content file has a directory name headed by “.”.

13. The device according to claim 10, wherein the device uses a number of times a first one of the content files has been hidden by a user as the characteristic information of the first content file, the processor being further configured to:
acquire the number of times the first content file has been hidden;
determine the display attribute of the first content file to be the first attribute if the acquired number of times is larger than a first preset threshold value;
determine the display attribute of the first content file to be the second attribute if the acquired number of times is smaller than the first preset threshold value and larger than a second preset threshold value; and
determine the display attribute of the first content file to be the third attribute if the acquired number of times is smaller than the second preset threshold value.

14. The device according to claim 10, wherein the device uses a display attribute mark of a first one of the content files set by a user as the characteristic information of the first content file, the processor being further configured to:
determine the display attribute of the first content file to be the first attribute if it is detected that the display attribute mark of the first content file is set as the first attribute;
determine the display attribute of the first content file to be the second attribute if it is detected that the display attribute mark of the first content file is set as the second attribute; and
determine the display attribute of the first content file to be the third attribute if it is detected that the display attribute mark of the first content file is set as the third attribute.

15. The device according to claim 14, wherein the display attribute mark of the first content file is modified through the application.

16. The device according to claim 10, the processor being further configured to:
upload the determined display attribute of a first one of the content files to a server.

17. The device according to claim 10, wherein when the application is an application for viewing pictures, the processor being further configured to:
hide a first plurality of pictures with the determined display attribute being the first attribute or the second attribute; and
display a second plurality of pictures with the determined display attribute being the third attribute.

18. The device according to claim 10, wherein when the application is a music player, the processor being further configured to:
hide a first plurality of music files with the determined display attribute being the first attribute or the second attribute; and
display a second plurality of music files with the determined display attribute being the third attribute.

19. A non-transitory computer-readable medium having stored therein instructions that, when executed by a processor of a device, causes the device to perform a method for displaying files, the method comprising:
acquiring, when opening an application, characteristic information of a plurality of content files relating to the application;
determining a display attribute of each of the content files based on the acquired characteristic information, the determined display attribute being one of a first attribute, a second attribute, and a third attribute; and
hiding ones of the content files with the determined display attribute being the first attribute or the second attribute, and displaying ones of the content files with the determined display attribute being the third attribute.
